(19) United States
(12) Patent Application Publication
(10) Pub. No.: US 2019/0143833 A1
(43) Pub. Date: May 16, 2019

(54) Method of Computing Dynamically Power Output of Electric Vehicle Power Train with Multiple Battery Packs

(71) Applicants: Fang Shen, San Jose, CA (US); Hua Shui, Shanghai (CN); Jie Chen, Shang Hai (CN)

(72) Inventors: Fang Shen, San Jose, CA (US); Hua Shui, Shanghai (CN); Jie Chen, Shang Hai (CN)

(21) Appl. No.: 15/810,096

(22) Filed: Nov. 12, 2017

(51) Int. Cl. B60L 11/18; B60L 3/00

(52) U.S. Cl. CPC B60L 11/1864; B60L 2240/547; B60L 3/0046; B60L 11/1861

(57) ABSTRACT

This invention provides a method of computing dynamically the maximum power output to electric vehicle (EV) power train from the multiple and independently controlled battery packs to ensure safety and proper protection of the electric system. This method applies to an EV with multiple or extendable number of battery packs and provides fast computation of number of connected battery packs, the SOC of each battery pack, maximum power output of each battery pack and maximum power output of all battery packs combined.

### FIELD OF THE INVENTION

The present invention relates to the field of electric vehicle technology, whose power train is energized by one or multiple battery packs. More specifically, the present invention is on how to compute dynamically the maximum power output from the multiple and independently controlled battery packs.

### BACKGROUND

Electric vehicles are gaining more and more people's attention. However, their mileage has also been one of the limiting applications drivers are most concerned about when the EV's rated mileage is unable to meet customer demand. A practical solution is to have the ability for drivers choose to extend the battery pack in parallel to increase the driving range.

Because EV's power train is powered by a set of battery packs in parallel, the combined maximum power output of the battery system is determined by the ability to access the total energy of each battery pack. More the battery packs are, more the maximum power output energy is, resulting in the improved performance of the vehicle such as fast starting, long drive range, etc.

The lithium battery-based systems have been popular to be the preferred choice EVs. However, when there are multiple battery packs and each of them have different electric characteristics such as degradation and reduced capacity and low SOC, the maximum power output to EV's power train needs to be adjusted. If not, battery packs may be damaged as a result of over-current, over-voltage or under-voltage.

### DESCRIPTION

This invention relates to an EV comprising with multiple and independently controlled battery packs.

Embodiments of the present invention comprise a battery pack management system (BMS) and battery, vehicle BMS, vehicle controller, driver controller, motor and battery pack switches, connecting wires.

Embodiments of the present invention allow the vehicle BMS to determine the maximum power available to vehicle motor. Referring to FIG. 1, the method of the present invention is a real-time system and consists of the following steps:
Step 1: Determine number of connected battery packs.
Step 2: Obtain SOC from connected battery packs and compute maximum power to vehicle controller.
Step 3: Enable vehicle controller to adjust the power to meet the maximum power requirement to protect the electric system.

In the embodiments of the Step 1, each battery pack has its own BMS that monitors and manages its own battery pack. The following data are communicated from the BMS of the battery pack to vehicle BMS: SOC, temperature, voltage, and current.

In the embodiments of the Step 1, the vehicle controller, via communication channels, directs discharging from each of the battery packs. The communication channels include CAN protocol, RS485, LIN or other short-distance communication protocols. The communications include also data transfers between the battery pack BMS, between battery pack BMS and vehicle BMS, and between vehicle controller and the rest of the vehicle components.

After start-up, low voltage system of the vehicle system is in ready state, and each of the battery pack BMS monitors its own battery pack including switch connection and error state if any. The vehicle BMS checks with the BMS of the battery packs, confirming the states and connections of the battery packs and send ready signal to vehicle controller.

In the embodiments of the Step 2, each BMS of the battery packs reads the voltage of its battery pack, computes its SOC and computes its maximum power reflecting to adjustment of the current temperature at the battery packs. Each BMS of the battery backs then sends the maximum power of each battery pack to the vehicle BMS which then aggregates the input data and computes the vehicle maximum power.

In the embodiments of the Step 2, the computation of SOC by battery pack BMS can be either based on open voltage method, or coulomb counting method.

In the embodiments of the Step 3, each BMS of the battery packs connects with the vehicle BMS and sends the maximum power of each battery pack to the vehicle BMS. The vehicle BMS aggregates them to compute the maximum power to the vehicle controller. It then sends the maximum power as control signal to the vehicle controller which then adjusts and controls the maximum power via DC/DC output level.

Referring to FIG. 2, in one embodiment, each BMS of the battery packs determines its battery pack switch states, its battery maximum power after the vehicle starts. In FIG. 2, all battery pack switches are connected correctly and all battery packs have the same maximum power of being 10 Kw. They are communicated to the vehicle BMS which determines the vehicle maximum power is 40 kw and communicates the data to vehicle controller.

Referring to FIG. 3, in this embodiment, each BMS of the battery packs determines its battery pack switch states, its battery maximum power after the vehicle starts. In FIG. 3, the battery pack switches 12 and 11 are connected correctly, but 10 and 9 are open. All battery packs have the same maximum power of being 10 Kw. Each BMS of the battery packs communicates the data to vehicle BMS which determines the vehicle maximum power is 20 kw and communicates the data to vehicle controller to prevent the over shot of maximum power to the motor.

Referring to FIG. 4, in this embodiment, each of the battery pack BMS determines its battery pack switch states, its battery maximum power after the vehicle starts. In FIG. 4, all battery pack switches are connected correctly, but the battery packs have different maximum power: they are 10 Kw, 8 Kw, 8 kw and 6 KW for battery packs 1 to 4, respectively. Each BMS of the battery packs communicate the data to vehicle BMS which determines the vehicle maximum power is 32 kw and communicates the data to vehicle controller to prevent the over shot of maximum power to the motor.

### BRIEF DESCRIPTION OF THE DRAWINGS

FIG. 1 shows a process diagram of implementing the method of adjusting the maximum output power for electric vehicles.

FIG. 2 shows a structural diagram of implementing the method of adjusting the maximum output power for electric vehicles with four battery packs and all closed position of switches.

FIG. 3 shows another structural diagram of implementing the method of adjusting the maximum output power for electric vehicles with four battery packs and two of them are in closed position of switches.

FIG. 4 shows a third structural diagram of implementing the method of adjusting the maximum output power for electric vehicles with four battery packs of different SOC states and all closed position of switches.

### DETAILED DESCRIPTION OF FIGURES

In the following detailed description, numerous specific details are set forth in order to provide a thorough understanding of the invention. The invention is not intended to be limited to the particular embodiments shown and described.

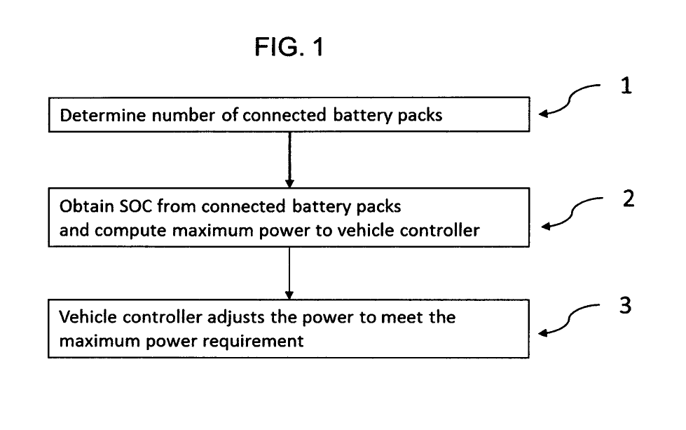

Referring to FIG. 1, the three steps of implementing the method of adjusting the maximum output power for electric vehicles includes: 1 Determine number of connected battery packs; 2 Obtain SOC from connected battery packs and compute maximum power to Vehicle controller, and 3 Vehicle controller adjusts the power to meet the maximum power requirement.

Referring to FIG. 1, the step of obtaining SOC from connected battery packs and computing maximum power to Vehicle controller is followed by the Step of obtaining SOC from connected battery packs and computing maximum power available to vehicle controller which is further followed by a step in which the vehicle controller adjusts the power to meet the maximum power requirement.

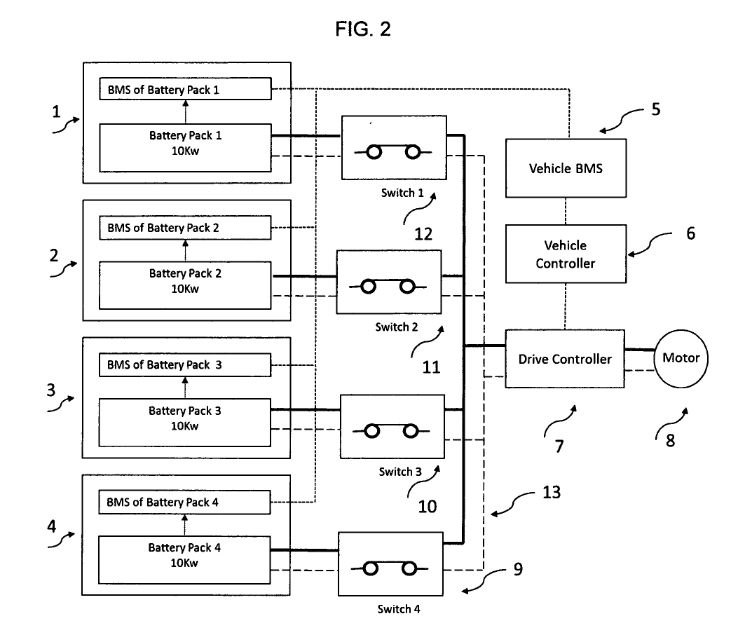

Referring to FIG. 2, in one embodiment, four battery packs 1 to 4 are connected to the driver controller 8 through 4 individual battery switches 12 to 9 with power connector wires 13. Four battery packs 1 to 4 are also feeding battery data to vehicle BMS 5 which further connected to the vehicle controller 6 that controls the drive controller 7, thus the motor 6 as well.

Referring to FIG. 2, in one embodiment, battery packs 1 to 4 have internal BMS that manages the battery pack itself. In this case, each battery has 10 KW capacity.

Referring to FIG. 2, in this embodiment, each of the battery pack BMS determines its battery pack switch states, its battery maximum power after the vehicle starts. In FIG. 2, all battery pack switches are connected correctly and all battery packs have the same maximum power of being 10 Kw. They are communicated to vehicle BMS which determines the vehicle maximum power is 40 kw and communicates the data to vehicle controller.

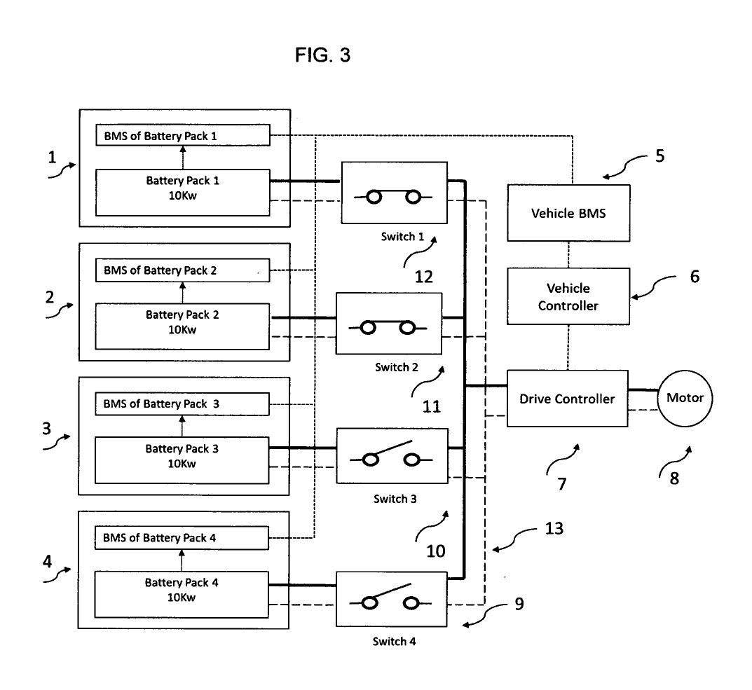

Referring to FIG. 3, in another embodiment, the configuration remains the same as FIG. 2 except that switches 10 and 9 are open.

Referring to FIG. 3, in this embodiment, battery packs 1 to 4 have internal BMS that manages its own battery pack. In this case, each battery has 10 KW capacity. They are communicated to vehicle BMS which determines the vehicle maximum power is 20 kw and communicates the data to vehicle controller.

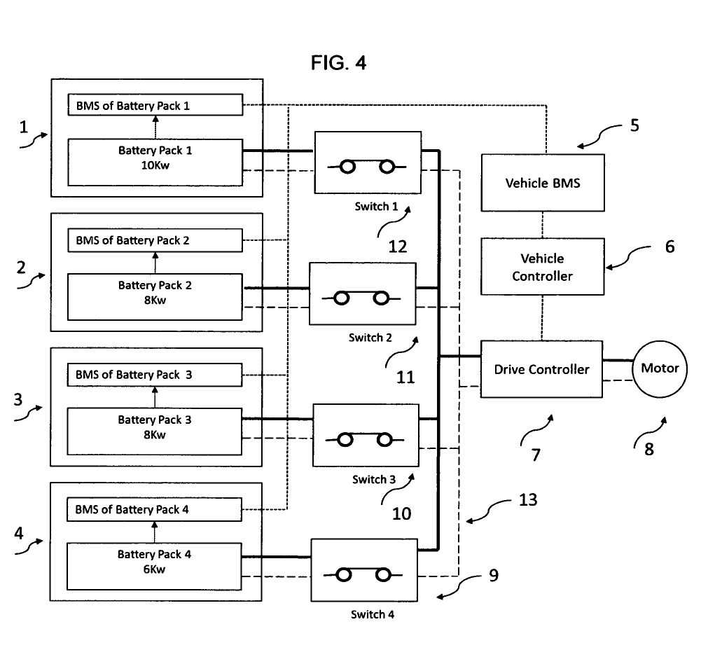

Referring to FIG. 4, in yet another embodiment, the configuration remains the same as FIG. 2 except that each battery pack's maximum power varies. The maximum powers of each battery packs are 10, 8, 8, and 6 Kw for battery pack 1 to 4, respectively.

Referring to FIG. 4, in this embodiment, battery packs 1 to 4 have internal BMS that manages the battery pack itself. In this case, each battery has different maximum power capacity. They are communicated to vehicle BMS which determines the vehicle maximum power is 32 kw and communicates the data to vehicle controller.

The above embodiments are for illustrative purposes and characteristics of the technical concept of the present invention and are not intended to limit the present invention, any modifications within the spirit and principles of the present invention, made, equivalents, etc., should be included in the scope of the present invention.

1. A method of computing dynamically the maximum power output of the battery systems available to the electric vehicle (EV) power train with multiple and independently controlled battery packs, comprising of confirming the number of battery packs connected; obtaining the state of charge of the battery packs and calculating the maximum power output of all battery packs; and adjusting dynamically the output power available to the EV power train through the vehicle controller.

2. The method of computing dynamically the maximum power output of the battery systems of claim 1, wherein confirming of number of connected battery packs comprises obtaining real-time state of the battery pack connection from the battery pack battery management system (BMS), and confirming that the battery packs have has been properly connected.

3. The method of computing dynamically the maximum power output of the battery systems of claim 1, wherein obtaining state of the charge (SOC) of the each battery pack comprises for the battery management system of each battery pack to acquire the voltage of individual battery back, and to calculate the state of charge of each battery pack.

4. The method of computing dynamically the maximum power output of the battery systems of claim 1, wherein calculating the maximum power output of all battery packs comprises for the battery management system to calculate the real-time maximum power output of each battery pack through the use of the state of charge and the temperature of each battery pack, and for the main battery management system to calculate the maximum power output of all properly connected battery packs.

5. The method of computing dynamically the maximum power output of the battery systems of claim 1, wherein adjusting the output power comprises for the main battery management system to send the maximum power as a limit parameter to the vehicle controller, and for the vehicle controller to calculate the need power of the vehicle system and to dynamically adjust the output power available to the EV power train.
